(19) United States
(12) Patent Application Publication
(10) Pub. No.: US 2014/0067982 A1
(43) Pub. Date: Mar. 6, 2014

(54) DETERMINING AN ESTIMATION OF MESSAGE RESPONSE TIME

(71) Applicants: Shadi E. Albouyeh, Raleigh, NC (US); Bernadette A. Carter, Raleigh, NC (US); Jon M. Harris, Raleigh, NC (US); Tintin S. Soemargono, Cary, NC (US)

(72) Inventors: Shadi E. Albouyeh, Raleigh, NC (US); Bernadette A. Carter, Raleigh, NC (US); Jon M. Harris, Raleigh, NC (US); Tintin S. Soemargono, Cary, NC (US)

(73) Assignee: INTERNATIONAL BUSINESS MACHINES CORPORATION, Armonk, NY (US)

(21) Appl. No.: 13/600,575

(22) Filed: Aug. 31, 2012

(51) Int. Cl. G06F 15/16

(52) U.S. Cl. 709/207

(57) ABSTRACT

A first computer receives a first chat message from a second computer within a first chat session. The first computer determines an initial estimated response time to the first chat message, based on chat history of a user of the first computer, and sends the initial estimated response time to the second computer. The first computer then determines a subsequent estimated response time, which is based on the activity of a user of the first computer. The first computer adds the initial estimated response time and the subsequent estimated response time to determine a total estimated response time, which is then sent to the second computer.

### FIELD OF THE INVENTION

The present invention relates generally to electronic text messaging systems, and more particularly to estimating when a recipient of a chat message will respond to the chat message.

### BACKGROUND

Chat messaging is a form of communication over the Internet, which offers near instantaneous transmission of text-based messages from sender to receiver. Chat messaging differs from other forms of electronic messaging technologies such as email because chat messages are typically exchanged in real time between two online users.

Early forms of chat messaging, while delivering real time chat capabilities, suffered due to the unpredictability of when a response to a chat message can arrive. After sending a chat message, users were forced to wait, not knowing whether their chat partner was actively responding to their chat message, had stepped away or was working on something else. In modern chat messaging applications, chat windows display notifications such as “User is typing” at the bottom of the chat window, in order to alert a user to the fact that a message is being currently composed by their chat partner. This feature of modern chat applications gives users an idea of when to expect the arrival of a new chat message, thereby eliminating some of the frustrations experienced by users of earlier chat applications.

### SUMMARY

Embodiments of the present invention provide a system, method, and program product for estimating when a recipient of a chat message will respond to the chat message. A first computer receives a first chat message from a second computer, wherein the first chat message is displayed in a first chat window. The first computer determines an estimated response time to the first chat message, wherein the estimated response time is an estimated time interval between the time that the first computer receives the first chat message and the time that a second chat message in response to the first chat message is transmitted to the second computer. The computer then sends the estimated response time to the second computer.

### BRIEF DESCRIPTION OF THE SEVERAL VIEWS OF THE DRAWINGS

FIG. 1 illustrates a response time estimation system, in accordance with an embodiment of the invention.

FIGS. 2 through 4 are a flowchart illustrating the operations of the activity monitoring program of FIG. 1 in determining estimated response times to a received chat message, in accordance with an embodiment of the invention.

FIG. 5 is a block diagram depicting the hardware components of the response time estimation system of FIG. 1, in accordance with an embodiment of the invention.

### DETAILED DESCRIPTION

As will be appreciated by one skilled in the art, aspects of the present invention can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present invention can take the form of a computer program product embodied in one or more computer-readable medium(s) having computer readable program code/instructions embodied thereon.

Any combination of one or more computer-readable medium(s) can be utilized. The computer-readable medium can be a computer-readable signal medium or a computer-readable storage medium. A computer-readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium can be any tangible medium that can contain, or store a program for use by or in connection with an instruction execution system, apparatus, or device.

A computer-readable signal medium can include a propagated data signal with computer-readable program code embodied therein, for example, in baseband or as part of a carrier wave. Such a propagated signal can take any of a variety of forms, including, but not limited to, electro-magnetic, optical, or any suitable combination thereof. A computer-readable signal medium can be any computer-readable medium that is not a computer-readable storage medium and that can communicate, propagate, or transport a program for use by or in connection with an instruction execution system, apparatus, or device.

Program code embodied on a computer-readable medium can be transmitted using any appropriate medium, including but not limited to wireless, wireline, optical fiber cable, RF, etc., or any suitable combination of the foregoing.

Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on a user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Embodiments of the present invention will now be described in detail with reference to the accompanying Figures.

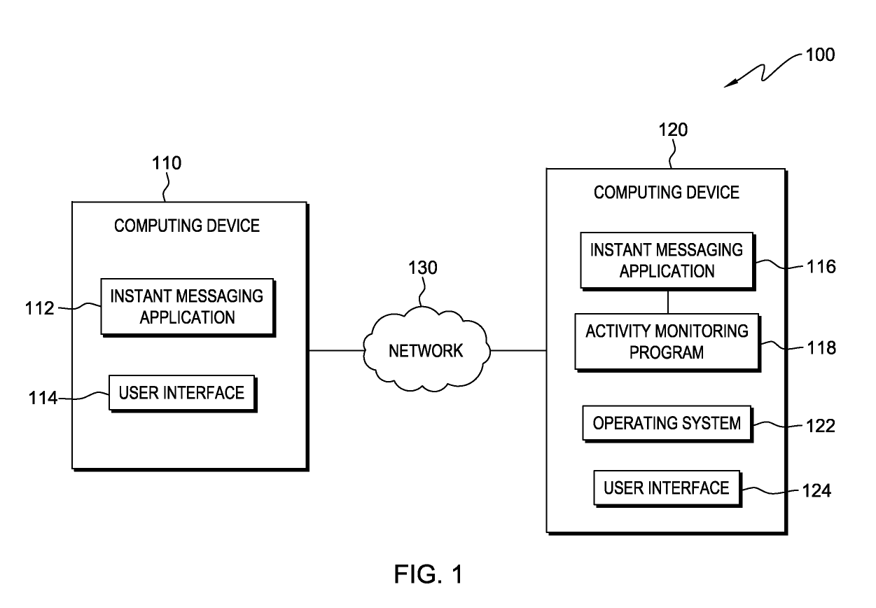

FIG. 1 illustrates response time estimation system 100, in accordance with an embodiment of the invention. Response time estimation system 100 includes computing device 110 and computing device 120, interconnected over network 130.

In an exemplary embodiment, network 130 is the Internet, representing a worldwide collection of networks and gateways to support communications between devices connected to the Internet. Network 130 can include, for example, wired, wireless or fiber optic connections. In other embodiments, network 130 can be implemented as an intranet, a local area network (LAN), or a wide area network (WAN). In general, network 130 can be any combination of connections and protocols that will support communications between computing device 110 and computing device 120.

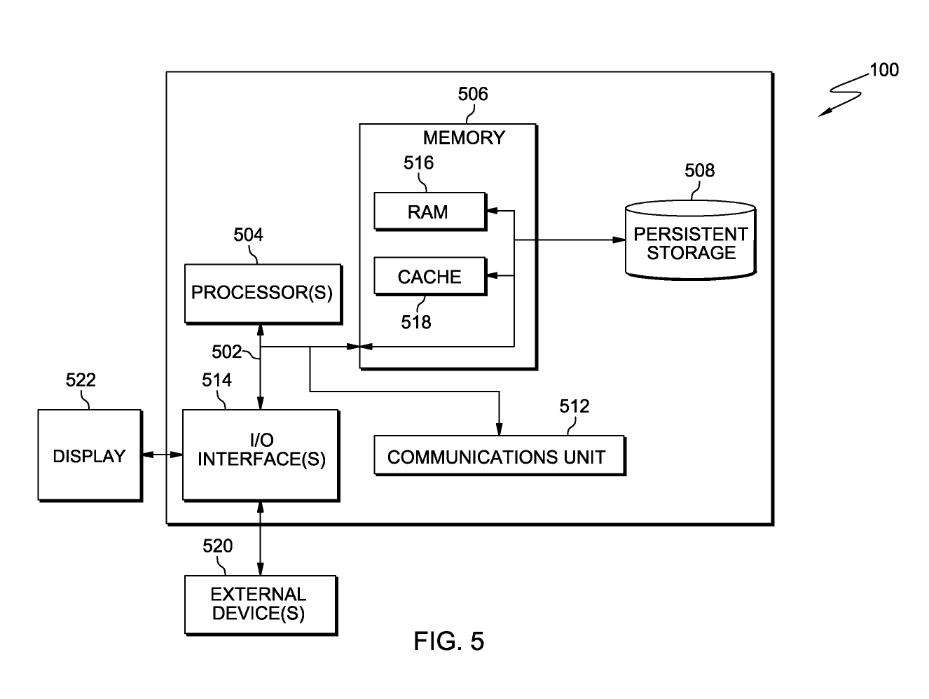

Computing device 110 includes instant messaging application 112 and user interface 114. Computing device 110 can be a desktop computer, a notebook, a laptop computer, a tablet computer, a handheld device, a smart-phone, a thin client, or any other electronic device or computing system capable of receiving and sending data to and from computing device 120 via network 130. Computing device 110 is described in more detail with reference to FIG. 5.

Instant messaging application 112 is a program that enables a user of computing device 110 to communicate in real time with another user via network 130. In an exemplary embodiment, the user communication is in the form of a textual message or “chat message” transmitted over network 130 and displayed to a user of another computing device, for example computing device 120, in a chat window.

User interface 114 includes components used to receive input from a user and communicate the input to an application. User interface 114 uses a combination of technologies and devices, such as device drivers, to provide a platform to enable users to interact with an application. In an exemplary embodiment, user interface 114 receives input, such as textual input received from a physical input device such as a keyboard, via a device driver that is associated with the physical input device. In the exemplary embodiment, user interface 114 communicates this input to instant messaging application 112 where it is displayed in a chat window on a display device, such as, for example, display device 522 (see FIG. 5).

Computing device 120 includes instant messaging application 116, activity monitoring program 118, operating system (OS) 122, and user interface 124. Computing device 120 can be a desktop computer, a notebook, a laptop computer, a tablet computer, a handheld device, a smart-phone, a thin client, or any other electronic device or computing system capable of receiving and sending data to and from computing device 110 via network 130. Computing device 120 is described in more detail with reference to FIG. 5.

Instant messaging application 116 is a counterpart to instant messaging application 112, described above, and operates in the same manner as instant messaging application 112.

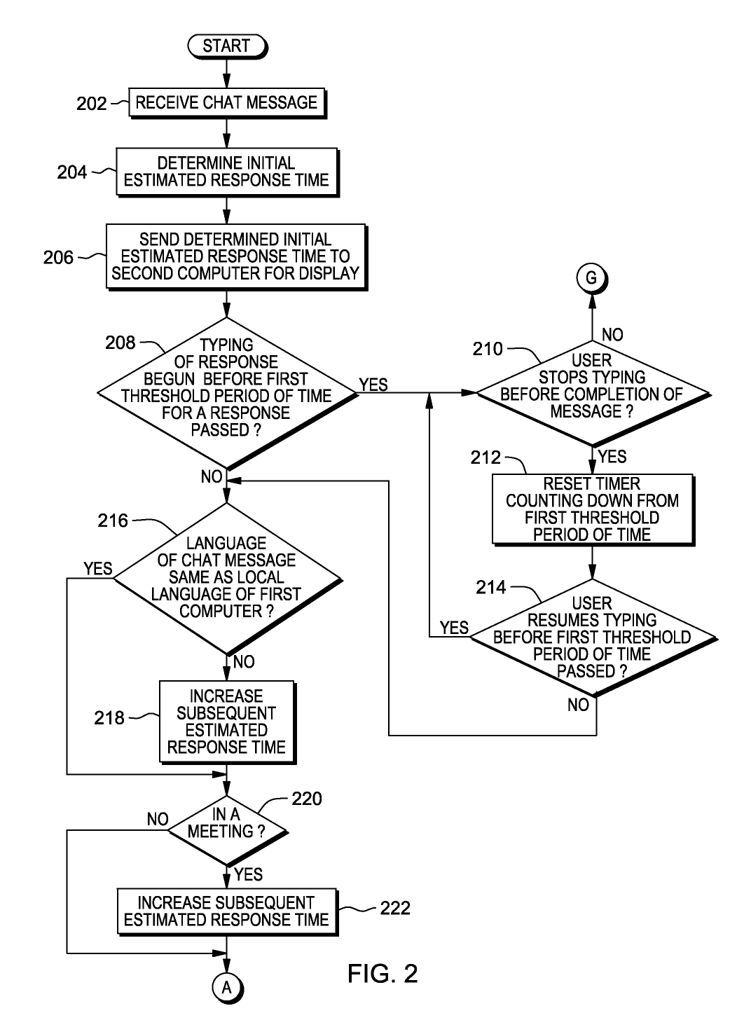

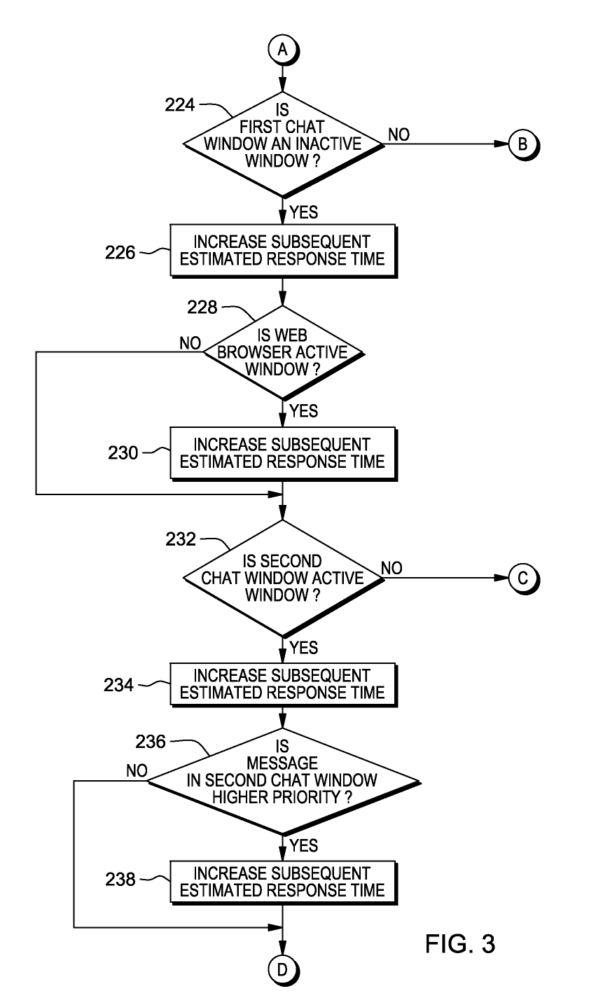

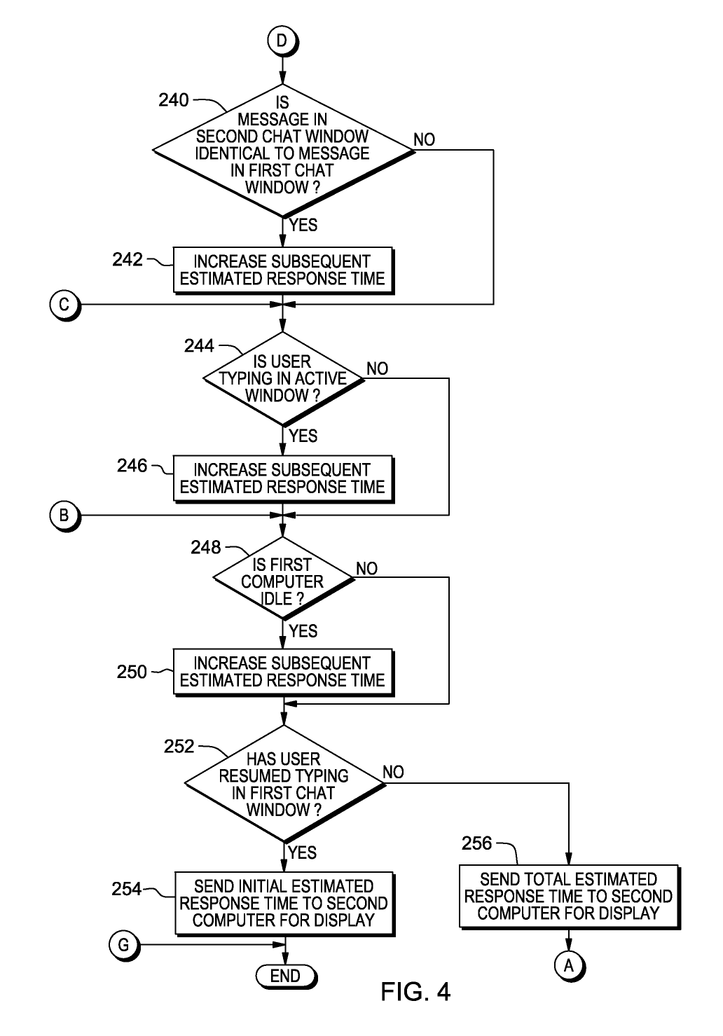

Activity monitoring program 118, the operation of which is explained in greater detail below with respect to FIGS. 2-4, operates to determine both an initial estimated response time and a subsequent estimated response time to a chat message received from another computing device, such as computing device 110, via network 130. In an exemplary embodiment, after a chat message is received by instant messaging application 116, for example from computing device 110, an initial estimated response time is determined by activity monitoring program 118 and sent to instant messaging application 112 on computing device 110. The initial estimated response time is an estimate of the amount of time it will take for the user of computing device 120 to send a response to the chat message received from computing device 110. In the exemplary embodiment, the initial estimated response time is determined based on the chat history of the user of computing device 120.

Activity monitoring program 118 can also determine a subsequent estimated response time. In the exemplary embodiment, the subsequent estimated response time is based on the computer activity of the user of computing device 120. For example, after receiving the chat message from computing device 110, if the chat window where the chat message is displayed to the user of computing device 120 goes inactive or the user of computing device 120 opens a web browser, the subsequent estimated response time is increased and added to the initial estimated response time. This newly calculated subsequent estimated response time is sent to computing device 110 so that the user of computing device 110 is aware that a response to the chat message can be delayed. While activity monitoring program 118 is shown as a separate component, in other embodiments, activity monitoring program 118 can be fully integrated with instant messaging application 116. The process of determining the initial and subsequent estimated response times is described in further detail with regard to FIGS. 2-4.

OS 122 can be Microsoft Windows™, Mac OS X™, Linux™, or any other operating system capable of processing local requests for information from computing device 120.

User interface 124 includes components used to receive input from a user and transmit the input to an application. User interface 124 uses a combination of technologies and devices, such as device drivers, to provide a platform to enable users to interact with an application. In an exemplary embodiment, user interface 124 receives input, such as textual input received from a physical input device, such as a keyboard, via a device driver that corresponds to the physical input device. In an exemplary embodiment, user interface 124 communicates this input to instant messaging application 116 and activity monitoring program 118.

FIGS. 2-4 show a flowchart illustrating the operations of activity monitoring program 118 in determining the initial estimated response time and subsequent estimated response time to a received chat message, in accordance with an exemplary embodiment of the invention. In an exemplary embodiment, activity monitoring program 118 residing on computing device 120 is invoked when a chat message is received from instant messaging application 112 via computing device 110 and network 130 (step 202). In the exemplary embodiment, the received chat message is displayed in a first chat window via instant messaging application 116. In another embodiment, activity monitoring program 118 is invoked when instant messaging application 116 is launched or initiated by computing device 120.

After instant messaging application 116 receives the chat message (step 202), activity monitoring program 118 then determines an initial estimated response time for a response to the received chat message (step 204). In an exemplary embodiment, activity monitoring program 118 determines the initial estimated response time by analyzing the chat history of the user of computing device 120, who is the recipient of the chat message, and determining the median time taken for the user to respond to previously received chat messages. In the exemplary embodiment, activity monitoring program 118 performs the initial estimated response time calculation for, for example, the first 1000 received chat messages. After the 1000 chat message threshold has been passed, the last calculated initial estimated response time remains the initial estimated response time from then. If the user of computing device 120 desires to re-establish the initial estimated response time determination, the user can do so by selecting a “re-establish option” provided by activity monitoring program 118 via user interface 124. The initial estimated response time calculation then starts over and repeats for every received chat message until the 1000 chat message threshold is passed again. In other embodiments of the invention, the initial estimated response time can include an interval relating to the network delay between computing device 110 and computing device 120.

After activity monitoring program 118 has determined an initial estimated response time (step 204), activity monitoring program 118 sends the determined initial estimated response time to computing device 110 via network 130 for display in the chat window of instant messaging application 112 (step 206). The initial estimated response time gives the user of computing device 110 a basic idea of how long it will take until the user of computing device 120 sends a response to the chat message. In an exemplary embodiment, once the initial estimated response time is received by computing device 110 and displayed in the chat window of instant messaging application 112, the displayed initial estimated response time begins to countdown towards zero. Once a response chat message from the user of computing device 120 is received by computing device 110, the initial estimated response time changes to zero if it has not reached zero already.

Once the initial estimated response time is transmitted to computing device 110 (step 206), activity monitoring program 118 determines if the user of computing device 120 has begun typing a response to the chat message received from computing device 110 before a first threshold period of time for a response to the chat message has passed (decision 208). This step is accomplished by activity monitoring program 118 communicating with OS 122 and requesting information regarding the current activity of computing device 120. In an exemplary embodiment, the first threshold period of time is 5 seconds. In other embodiments, the first threshold period of time can be any amount of time that serves the purpose of defining a reasonable time interval within which a user can be expected to begin entering a response message. If the user of computing device 120 has not begun typing a response to the chat message received from computing device 110 before a first threshold period of time for a response to the chat message has passed (decision 208, “NO” branch), activity monitoring program 118 moves onto decision 216 and calculates a subsequent estimated response time. If the user of computing device 120 has begun typing a response to the chat message received from computing device 110 before a first threshold period of time for a response to the chat message has passed (decision 208, “YES” branch), activity monitoring program 118 determines if the user of computing device 120 stopped typing before completion of the response message (decision 210). In an exemplary embodiment, the completeness of the response message is determined based on whether the response message has been transmitted to computing device 110. In other words, if the user of computing device 120 stops typing the response message without subsequently transmitting the response message to computing device 110 within a small period of time, for example 5 seconds, the response message is considered incomplete. This determination is accomplished by activity monitoring program 118 communicating with OS 122 and requesting information regarding the current activity of computing device 120.

If activity monitoring program 118 determines that the user of computing device 120 did not stop typing before completion of the response to the chat message received from computing device 110 (decision 210, “NO” branch), the already sent initial estimated response time continues to countdown to zero in the chat window of instant messaging application 112 until the response to the chat message is received by computing device 110, at which time the displayed initial estimated response time changes to zero. If activity monitoring program 118 determines that the user of computing device 120 has stopped typing before completion of the response to the chat message received from computing device 110 (decision 210, “YES” branch), activity monitoring program 118 resets the timer counting down from the first threshold period of time for a response to the chat message received from computing device 110, and restarts the countdown from the first threshold period of time (step 212).

Once the timer counting down from the first threshold period of time for a response to the chat message received from computing device 110 is restarted (step 212), activity monitoring program 118 determines if the user has resumed typing the response before the first threshold period of time has passed (decision 214). If activity monitoring program 118 determines that the user has resumed typing the response before the first threshold period of time has passed (decision 214, “YES” branch), activity monitoring program 118 determines if the user of computing device 120 stopped typing before completing the response (decision 210). If activity monitoring program 118 determines that the user has not resumed typing the response before the first threshold period of time has passed (decision 214, “NO” branch), activity monitoring program 118 calculates a subsequent estimated response time (decision 216).

Activity monitoring program 118 calculates the subsequent estimated response time based on the results of several determinations which are detailed below. The calculated subsequent estimated response time is added to the initial estimated response time to formulate the total estimated response time.

Activity monitoring program 118 determines if the language of the chat message is the same as the local language of computing device 120 (decision 216). In other words, activity monitoring program 118 determines if the language the chat message is written in is the same as the language computing device 120 is set to operate in. Within the confines of this determination, the term “language” specifically refers to human languages, such as Spanish or French. In an exemplary embodiment, to perform this determination, activity monitoring program 118 first analyzes the chat message using language recognition software. Then, activity monitoring program 118 sends a request for information to OS 122, requesting the name of the language computing device 120 is currently using. If the language of the chat message is the same as the language computing device 120 is set to operate in (decision 216, “YES” branch), activity monitoring program moves on to the next determination (decision 220). If the language of the chat message is different from the language computing device 120 is set to operate in (decision 216, “NO” branch), activity monitoring program increases the subsequent estimated response time by a preset value (step 218). This preset value takes into account the possible delay in time a user can incur by having to type a response to a chat message in a language that is not the user's native tongue. For example, if activity monitoring program 118 determines that the language of the chat message is English and the language that computing device 120 is set is French, activity monitoring program 118 increases the estimated response time to account for the possibility that a French user can take longer than an English user to compose a response message in English.

Activity monitoring program 118 then determines if the user of computing device 120 is in a meeting (decision 220). In an exemplary embodiment, activity monitoring program 118 makes this determination by communicating with instant messaging application 116 and requesting information regarding the current availability of the user of computing device 120. In the exemplary embodiment, instant messaging application 116 includes either or both current status information, such as “in a meeting” or “busy”, and a calendar application, which the user of computing device 120 can use to log meetings and daily activities. In other embodiments, activity monitoring program 118 also determines if a voice over IP phone connection connected to computing device 120, or any other telephone device connected to computing device 120 is in use. This is accomplished by activity monitoring program 118 requesting information from OS 122 regarding the voice over IP phone activity. Activity monitoring program 118 analyzes this information to determine if the user of computing device 120 is currently in a meeting or otherwise engaged (“busy” or on the phone). If activity monitoring program 118 determines the user of computing device 120 is in a meeting or otherwise engaged (decision 220, “YES” branch), activity monitoring program 118 increases the subsequent estimated response time by a preset value (step 222). This preset value takes into account the delay in time created by the user of computing device 120 being in a meeting or being otherwise engaged. If activity monitoring program 118 determines the user of computing device 120 is not in a meeting or otherwise engaged (decision 220, “NO” branch), activity monitoring program 118 moves on to the next determination (decision 224).

Activity monitoring program 118 then determines if the first chat window on computing device 120, which displays the chat message received from computing device 110, is an inactive window (decision 224). In an exemplary embodiment, activity monitoring program 118 makes this determination by communicating with OS 122 and requesting information regarding the current activity of computing device 120. If activity monitoring program 118 determines that the first chat window is not an inactive window (decision 224, “NO” branch), activity monitoring program 118 moves on to decision 248. If activity monitoring program 118 determines that the first chat window is an inactive window (decision 224, “YES” branch), activity monitoring program 118 increases the subsequent estimated response time by a preset value (step 226). This preset value takes into account the delay in time that can be incurred from the first chat window being inactive. Presumably, if the first chat window is inactive, the user of computing device 120 is performing other tasks in another active window. If the first chat window is determined to be inactive, activity monitoring program 118 determines if additional delays can be incurred from the other activity of the user of computing device 120.

If the first chat window is determined to be inactive (decision 224, “YES” branch), activity monitoring program determines if the active window is a web browser (decision 228). In an exemplary embodiment, activity monitoring program 118 makes this determination by once again communicating with OS 122 and requesting information as to the current active window. If the active window is a web browser (decision 228, “YES” branch), activity monitoring program 118 increases the subsequent estimated response time by a preset value (step 230). This preset value is an estimation of the delay in time that can be incurred from a user performing a web search before sending a response to the chat message. If the active window is not a web browser (decision 228, “NO” branch), activity monitoring program 118 moves on to the next determination (decision 232).

Activity monitoring program 118 then determines if a second chat window is the active window (decision 232). In an exemplary embodiment, activity monitoring program 118 makes this determination by communicating with OS 122 and requesting information as to the current active window. If the active window is determined to be a second chat window (decision 232, “YES” branch), activity monitoring program 118 increases the subsequent estimated response time by a preset value (step 234). This preset value takes into account the delay in time that can be incurred from a user participating, at least momentarily, in a second chat session before responding to the initial chat message received from computing device 110 via network 130. If the active window is determined to not be a second chat window (decision 232, “NO” branch), activity monitoring program 118 moves on to decision 244.

If activity monitoring program 118 determines the active window is a second chat window (decision 232, “YES” branch), activity monitoring program 118 then determines if the message displayed in the second chat window has a higher priority level than the chat message received from computing device 110 (decision 236). In an exemplary embodiment, priority levels are assigned by the user of computing device 120 to each chat partner saved in instant messaging application 116. For example, the user of computing device 120 can assign a higher priority level to a manager as opposed to a co-worker. In the exemplary embodiment, each time a new chat partner is added/saved in instant messaging application 116, the user of computing device 120 is prompted by activity monitoring program 118 to assign a priority value to the newly added chat partner. Each time a chat message is received by computing device 120, activity monitoring program 118 identifies the priority level of the sending user of the chat message. Activity monitoring program 118 then assigns the identified priority level to the received chat message. In another embodiment, instant messaging application 116 can prompt the user of computing device 120 to assign a priority value to a newly added chat partner. In this embodiment, each time a chat message is received by computing device 120, activity monitoring program 118 communicates with instant messaging application 116 to identify the priority level of the sending user. Activity monitoring program 118 then assigns the identified priority level to the received chat message. In other embodiments, activity monitoring program 118 or instant messaging application 116 prompts the user of computing device 120 to input keywords that the user of computing device 120 considers high priority. Each keyword input by the user of computing device 120 can be assigned a different level of priority; depending on how important the user of computing device 120 considers each keyword. As each chat message is received by computing device 120, activity monitoring program 118 searches the chat message for the designated keywords. If the chat message contains one or more designated keywords, the priority level assigned to the chat message is equal to the priority level of the highest priority keyword found in the received chat message. If the chat message does not contain any designated keywords, activity monitoring program 118 labels it as low priority. If activity monitoring program 118 determines the message displayed in the second chat window has a higher priority level than the chat message received from computing device 110 (decision 236, “YES” branch), activity monitoring program 118 increases the subsequent estimated response time by a preset value (step 238). This preset value takes into account the delay in time created by the user of computing device 120 responding to the higher priority chat message displayed in the second chat window before responding to the chat message received from computing device 110. If activity monitoring program 118 determines the message displayed in the second chat window does not have a higher priority level than the chat message received from computing device 110 (decision 236, “NO” branch), activity monitoring program moves on to the next determination (decision 240).

If activity monitoring program 118 determines the active window is a second chat window (decision 232, “YES” branch), activity monitoring program 118 then determines if the chat message in the second chat window is identical to the chat message received from computing device 110 (decision 240). Making this determination allows activity monitoring program 118 to account for delays caused by situations in which the user of computing device 120 is asked a question via the received initial chat message from computing device 110, is unaware of the answer, and asks the same question to a third user via a second chat window. The user of computing device 120 must then wait for a response to the question asked in the second chat window before responding to the initial chat message, creating a delay. In an exemplary embodiment, making this determination involves two steps. First, activity monitoring program 118 determines if the user of computing device 120 has initiated a second chat session via a second chat window. This determination is accomplished by activity monitoring program 118 communicating with OS 122 regarding computer activity on computing device 120. This first step eliminates situations where a message from a third user is received by the user of computing device 120 asking the same question as the initial chat message received from the user of computing device 110, in which case, there can not be a significant delay in response time to the initial chat message. In a second step, activity monitoring program 118 uses character recognition software to analyze and compare the initial chat message received from computing device 110 to the chat message in the second chat window. If activity monitoring program 118 determines the two chat messages are identical (decision 240, “YES” branch), activity monitoring program 118 increases the subsequent estimated response time by a preset value (step 242). In another embodiment, activity monitoring program 118 compares the two chat messages to see if their content is substantially similar to the extent where they can be considered identical. If the character recognition software determines that the similarities between the two chat messages, i.e., similarities between the content and order of the content of the two chat messages, surpass a predetermined threshold value, the two chat messages will be considered identical for the purposes of this determination and activity monitoring program 118 will increase the subsequent estimated response time by a preset value (step 242). If activity monitoring program 118 determines that the two chat messages are not identical (decision 240, “NO” branch), activity monitoring program 118 moves on to the next determination (decision 244).

Activity monitoring program 118 then determines if the user of computing device 120 is typing in the active window (decision 244). Once it has been determined that the first chat window is inactive, if the user of computing device 120 is typing in the active window, then presumably his response time will be further delayed. In an exemplary embodiment, activity monitoring program 118 makes this determination by once again communicating with OS 122 and requesting information regarding the current activity of computing device 120. If activity monitoring program 118 determines that the user of computing device 120 is typing in the active window (decision 244, “YES” branch), activity monitoring program 118 increases the subsequent estimated response time by a preset value (step 246). This preset value takes into account the delay in time that can be incurred from a user typing or more specifically actively performing a task within the active window. If activity monitoring program 118 determines that the user of computing device 120 is not typing in the active window (decision 244, “NO” branch), activity monitoring program 118 moves on to the next determination (decision 248).

Activity monitoring program 118 then determines if computing device 120 is idle (decision 248). In an exemplary embodiment, computing device 120 is idle if computing device 120 has remained inactive for a period of time, for example, 15 seconds. In the exemplary embodiment, activity monitoring program 118 makes this determination by communicating with OS 122 and requesting information about the activity of computing device 120. If activity monitoring program 118 determines that computing device 120 is idle (decision 248, “YES” branch), activity monitoring program 118 increases the subsequent estimated response time by a preset value (step 250). This preset value takes into account the delay in time that can be incurred from computing device 120 being idle. In an exemplary embodiment, the preset value for this determination is the median of all idle time periods that occurred previously while instant messaging application 116 was running. If activity monitoring program 118 determines that computing device 120 is not idle (decision 248, “NO” branch), activity monitoring program 118 moves on to the next determination (decision 252).

Activity monitoring program 118 then determines if the user of computing device 120 has resumed typing in the first chat window (decision 252). In an exemplary embodiment, activity monitoring program 118 makes this determination by communicating with OS 122 and requesting information regarding the current activity of computing device 120. If activity monitoring program 118 determines that the user of computing device 120 has resumed typing in the first chat window (decision 252, “YES” branch), activity monitoring program 118 sends the determined initial estimated response time to computing device 110 via network 130 for display in the chat window of instant messaging application 112 (step 254). If activity monitoring program 118 determines that the user of computing device 120 has not resumed typing in the first chat window (decision 252, “NO” branch), activity monitoring program 118 sends the total estimated response time to computing device 110 via network 130 for display in the chat window of instant messaging application 112 (step 256). As stated above, the total estimated response time is the sum of the initial estimated response time and the subsequent estimated response time. In an exemplary embodiment, once the total estimated response time is received by computing device 110 and displayed in the chat window of instant messaging application 112, the displayed total estimated response time begins to countdown towards zero. After sending the total estimated response time to computing device 110, activity monitoring program 118 returns to decision 216 and repeats each determination until activity monitoring program 118 determines, through communication with OS 122, that the user of computing device 120 has resumed typing in the first chat window.

The specific determinations described in FIGS. 2-4, which are used to calculate the estimated response time, are an extensive but not exhaustive list of determinations. In other embodiments, other determinations, not discussed in FIGS. 2-4, can be included in the calculation of the estimated response time. Also, while FIG. 1 depicts activity monitoring program 118 as existing on computing device 120, the Figure is depicted in this manner solely for the purposes of simplicity and clarity. A second activity monitoring program, capable of performing all the operations and determinations of activity monitoring program 118 described in FIGS. 2-4, can also exist on computing device 110.

The foregoing description of various embodiments of the present invention has been presented for purposes of illustration and description. It is not intended to be exhaustive nor to limit the invention to the precise form disclosed. Many modifications and variations are possible. Such modifications and variations that can be apparent to a person skilled in the art of the invention are intended to be included within the scope of the invention as defined by the accompanying claims.

FIG. 5 depicts a block diagram of components of computing device 110 and computing device 120, in accordance with an illustrative embodiment of the present invention. It should be appreciated that FIG. 5 provides only an illustration of one implementation and does not imply any limitations with regard to the environments in which different embodiments can be implemented. Many modifications to the depicted environment can be made.

Computing device 110 and computing device 120 include communications fabric 502, which provides communications between computer processor(s) 504, memory 506, persistent storage 508, communications unit 512, and input/output (I/O) interface(s) 514. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 516 and cache memory 518. In general, memory 506 can include any suitable volatile or non-volatile computer-readable storage media.

The programs instant messaging application 112 and user interface 114 in computing device 110; and the one or more operating systems 122 and programs instant messaging application 116, activity monitoring program 118, and user interface 124 in computing device 120 are stored in persistent storage 508 for execution by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 can also be removable. For example, a removable hard drive can be used for persistent storage 508. Other examples include optical and magnetic disks, thumb drives, and smart cards that are inserted into a drive for transfer onto another computer-readable storage medium that is also part of persistent storage 508.

Communications unit 512, in these examples, provides for communications with other data processing systems or devices. In these examples, communications unit 512 includes one or more network interface cards. Communications unit 512 can provide communications through the use of either or both physical and wireless communications links. The programs instant messaging application 112 and user interface 114 in computing device 110; and programs instant messaging application 116, activity monitoring program 118, and user interface 124 in computing device 120 can be downloaded to persistent storage 508 through communications unit 512.

I/O interface(s) 514 allows for input and output of data with other devices that can be connected to computing device 110 and computing device 120. For example, I/O interface 514 can provide a connection to external devices 520 such as a keyboard, keypad, a touch screen, and/or some other suitable input device. External devices 520 can also include portable computer-readable storage media such as, for example, thumb drives, portable optical or magnetic disks, and memory cards. Software and data used to practice embodiments of the present invention, e.g., programs instant messaging application 112 and user interface 114 in computing device 110; and programs instant messaging application 116, activity monitoring program 118, and user interface 124 in computing device 120, can be stored on such portable computer-readable storage media and can be loaded onto persistent storage 508 via I/O interface(s) 514. I/O interface(s) 514 also connect to a display 522.

Display 522 provides a mechanism to display data to a user and can be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer implemented method for estimation of time to respond to a chat message, comprising the steps of:
receiving a first chat message on a first computer from a second computer, wherein the first chat message is displayed in a first chat window;
determining an estimated response time, wherein the estimated response time is an estimated time interval between the time that the first computer receives the first chat message and the time that a second chat message in response to the first chat message is transmitted to the second computer; and
sending the estimated response time to the second computer.

2. The computer implemented method of claim 1, wherein the computer implemented method of claim 1 further comprises:
determining that a first threshold period of time for a response to the first chat message has been surpassed;
responsive to determining the first threshold period of time for a response to the first chat message has been surpassed, determining a subsequent estimated response time, wherein the subsequent estimated response time is determined based on activity of the user of the first computer; and
sending a total estimated response time to the second computer, wherein the total estimated response time is the sum of the estimated response time and the subsequent estimated response time.

3. The computer implemented method of claim 2, wherein the step of determining the subsequent estimated response time further comprises:
determining the first computer has remained idle for a period of time exceeding a second threshold period of time; and
increasing the subsequent estimated response time by a predetermined amount.

4. The computer implemented method of claim 2, wherein the step of determining the subsequent estimated response time further comprises:
determining if the first chat window is an inactive window; and
responsive to determining that the first chat window is the inactive window, increasing the subsequent estimated response time by a predetermined amount.

5. The computer implemented method of claim 2, wherein the step of determining the subsequent estimated response time further comprises:
determining a language of the first chat message;
determining if the language of the first chat message is different than a language currently used on the first computer; and
responsive to determining the language of the first chat message is different than the language currently used on the first computer, increasing the subsequent estimated response time by a predetermined amount.

6. The computer implemented method of claim 2, further comprising the steps of:
determining if the second chat message is being typed in the first chat window; and
responsive to determining that the second chat message is being typed in the first chat window, sending the estimated response time to the second computer.

7. The computer implemented method of claim 2, further comprising the steps of:
determining if the user of the first computer is currently in a meeting; and
responsive to determining the user of the first computer is currently in a meeting, increasing the subsequent estimated response time by a predetermined amount.

8. The computer implemented method of claim 4, further comprising the steps of:
determining if a second chat window is the active window, wherein a third chat message is displayed in the second chat window; and
responsive to determining that the second chat window is the active window, increasing the subsequent estimated response time by a predetermined amount.

9. The computer implemented method of claim 8, further comprising the steps of:
determining if the third chat message displayed in the second chat window is higher priority than the first chat message; and
responsive to determining that the third chat message displayed in the second chat window is higher priority than the first chat message, increasing the subsequent estimated response time by a predetermined amount.

10. The computer implemented method of claim 8, further comprising the steps of:
determining if content of the third chat message displayed in the second chat window is substantially similar to the content of the first chat message; and
responsive to determining the content of the third chat message displayed in the second chat window is substantially similar to the content of the first chat message, increasing the subsequent estimated response time by a predetermined amount.

11. A computer readable storage medium tangibly embodying a computer readable program code having computer readable instructions which, when implemented, cause a computer to carry out the steps of a method comprising:
receiving a first chat message on a first computer from a second computer, wherein the first chat message is displayed in a first chat window;
determining an estimated response time, wherein the estimated response time is an estimated time interval between the time that the first computer receives the first chat message and the time that a second chat message in response to the first chat message is transmitted to the second computer; and
sending the estimated response time to the second computer.

12. The computer program product of claim 11, wherein the steps of the method further comprise:
determining if a first threshold period of time for a response to the first chat message has been surpassed;
responsive to determining the first threshold period of time for a response to the first chat message has been surpassed, determining a subsequent estimated response time, wherein the subsequent estimated response time is determined based on activity of the user of the first computer; and
sending a total estimated response time to the second computer, wherein the total estimated response time is the sum of the estimated response time and the subsequent estimated response time.

13. The computer program product of claim 12, wherein the steps of the method further comprise:
determining the first computer has remained idle for a period of time exceeding a second threshold period of time; and
increasing the subsequent estimated response time by a predetermined amount.

14. The computer program product of claim 12, wherein the steps of the method further comprise:
determining if the first chat window is an inactive window; and
responsive to determining that the first chat window is the inactive window, increasing the subsequent estimated response time by a predetermined amount.

15. The computer program product of claim 12, wherein the steps of the method further comprise:
determining a language of the first chat message;
determining if the language of the first chat message is different than a language currently used on the first computer; and
responsive to determining the language of the first chat message is different than the language currently used on the first computer, increasing the subsequent estimated response time by a predetermined amount.

16. The computer program product of claim 12, wherein the steps of the method further comprise:
determining if the second chat message is being typed in the first chat window; and
responsive to the determining that the second chat message is being typed in the first chat window, sending the estimated response time to the second computer.

17. The computer program product of claim 14, wherein the steps of the method further comprise:
determining if a second chat window is the active window, wherein a third chat message is displayed in the second chat window; and
responsive to determining that the second chat window is the active window, increasing the subsequent estimated response time by a predetermined amount.

18. The computer program product of claim 17, wherein the steps of the method further comprise:
determining if the third chat message displayed in the second chat window is higher priority than the first chat message; and
responsive to determining that the third chat message displayed in the second chat window is higher priority than the first chat message, increasing subsequent estimated response time by a predetermined amount.

19. The computer program product of claim 17, wherein the steps of the method further comprise:
determining if content of the third chat message displayed in the second chat window is substantially similar to the content of the first chat message; and
responsive to determining the content of the third chat message displayed in the second chat window is substantially similar to the content of the first chat message, program increasing the subsequent estimated response time by a predetermined amount.

20. A computer system for estimation of time to respond to a chat message, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions, when implemented, causing the computer system to carry out the steps of a method comprising:
a processor receiving a first chat message on a first computer from a second computer, wherein the first chat message is displayed in a first chat window;
the processor determining an estimated response time, wherein the estimated response time is an estimated time interval between the time that the first computer receives the first chat message and the time that a second chat message in response to the first chat message is transmitted to the second computer; and
the processor sending the estimated response time to the second computer.
